(19) United States
(12) Patent Application Publication
(10) Pub. No.: US 2025/0014482 A1
(43) Pub. Date: Jan. 9, 2025

(54) FLEXIBLE SELF-ADHESIVE LABEL WITH A COVERED ADHESIVE REGION SELECTIVELY PEELABLE AND CLOSEABLE PRODUCT INCLUDING SAID LABEL

(71) Applicant: Arconvert, S.A.U., Sant Gregori (ES)

(72) Inventor: José Gamundi Masqué, Terrassa, Barcelona (ES)

(73) Assignee: Arconvert, S.A.U., Sant Gregori (ES)

(21) Appl. No.: 18/705,668

(22) PCT Filed: Oct. 24, 2022
(86) PCT No.: PCT/EP2022/079588

§ 371 Date: Apr. 29, 2024

(30) Foreign Application Priority Data
Oct. 28, 2021 (ES) U202132120

(51) Int. Cl. G09F 3/02; B65D 27/28; B65D 33/16; B65D 33/34; B65D 55/06; C09J 7/38; C09J 7/40; G09F 3/00

(52) U.S. Cl. CPC G09F 3/02883; B65D 27/28; B65D 33/1691; B65D 33/34; B65D 55/06; C09J 7/38; C09J 7/403; G09F 3/0292; C09J 2203/334; C09J 2301/122; C09J 2301/302; G09F 2003/0222; G09F 2003/0225; G09F 2003/0241; G09F 2003/0266; G09F 2003/0272

(57) ABSTRACT

Flexible self-adhesive label with a covered adhesive region selectively peelable, the label comprising a flexible layer (10); a pressure-sensitive adhesive layer (20) covering at least a first region (22) of a first side of the flexible layer (10); a liner (30) with a first liner region (32) adhered over the first region (22) and intended to be removed from the first region (22) leaving it exposed; wherein the adhesive layer (20) also covers a second region (23) of the first side of the flexible layer (10); and the liner (30) includes a base region (31), attached to the second region, the base region (31) and the first liner region (32) being connected through a first fold line (33) whose ends are approximately tangent to anti-tear configurations (36) of the liner (30), allowing to expose the first region (22) keeping the liner (30) attached to the second region (23).

### TECHNICAL FIELD

The present invention concerns a flexible self-adhesive label with an adhesive region covered by a liner which is selectively peelable, leaving the adhesive region exposed.

When the flexible self-adhesive label is adhered to a closeable product, such an envelope, a pouch, a bag, a box or a similar product, for example intended for filling with a self-service product or for storing items in a secure manner. The peeling of the adhesive region allows the closing of said closeable product by adhering the exposed adhesive region to a surface of such closeable product providing a closure of the closeable product, optionally also providing a tamper-evident seal.

Alternatively, the flexible self-adhesive label can be an elongated label with the selectively peelable adhesive region on one extreme portion thereof, the elongated label being foldable adhering the adhesive region on the opposed extreme portion thereof forming a loop, for example for retaining the label to a suitcase handle as a luggage tag.

Optionally, the surface of the other extreme portion, intended to be adhered to the first region, further comprises an additional first region and an additional second region of the adhesive layer covered by an additional liner with the same configuration described in regard to the opposed extreme portion of the elongated label.

The first regions of the adhesive layer of both extreme portions can be adhered to each other.

The additional liner will include an additional base region, attached to the additional second region, the additional base region and the additional first liner region being connected through an additional first fold line whose ends are approximately tangent to two cuts constitutive of anti-tear configurations of the additional protective liner, allowing to expose the additional first region keeping the additional liner attached to the additional second region of the adhesive layer.

### STATE OF THE ART

Flexible adhesive labels, consisting of a flexible layer with a layer of pressure-sensitive adhesive on one side, are widely known in the packaging field.

It is also known that some areas of the adhesive layer are, temporarily, covered with a liner, allowing an end user to remove such liner at the time of use of the product, for example through document US2019359391A1.

However, a common problem with this type of product is that the liner detaches from the adhesive label when it is removed, becoming a waste product that is often disposed incorrectly, generating dirt and contamination.

Document EP0677832 describes an alternative solution where a first label is adhered to a package, and a second label is adhered on top of the first label, the second label including two different portions with anti-tear configurations separating such portions allowing for a separation of only one portion of the second label from the first label. This solution is expensive to implement because it requires two overlapped adhesive labels.

Documents US2020130912, U.S. Pat. Nos. 5,582,889, 8,783,454 and 7,007,423 describe different flexible self-adhesive labels with an adhesive region covered by a liner.

The present invention proposes a solution to the above and other problems.

### BRIEF DESCRIPTION OF THE INVENTION

The present invention proposes a flexible self-adhesive label with an adhesive region covered by a liner, the covering being selectively peelable.

The proposed label comprises a flexible layer, a pressure-sensitive adhesive layer disposed at least on areas of a first side of the flexible layer and a liner adhered on at least parts of the adhesive layer.

The flexible layer can be, for example, a coated or uncoated paper, or a plastic film such a film made of PE, PP, PET, PVC, PU, PO, or other polymers. The liner can either be paper based—it can be for example a glassine, a CCK (Clay coated Kraft) or a SCK (Super Clanedered Kraft) or plastic film based, preferably PET. In all cases the liner has release properties to ensure that it is easy peelable from the adhesive layer. Such release properties are preferably obtained by coating the liner with a layer of silicone based release.

The flexible layer and/or the liner can printed, preferably on the sides, regions or surfaces where no adhesive layer is applied, typically including information thereon.

A pressure-sensitive adhesive shall be understood to be a non-reactive adhesive that forms a bond when pressure is applied to bond the adhesive to a surface. Once the pressure-sensitive adhesive has been applied on the label, no solvent, water or heat is required to produce the adhesion thereof on a surface contacting the adhesive.

The adhesive layer covers at least a first region of the first side of the flexible layer.

The liner comprises a first liner region adhered over the first region of the adhesive layer. Said first liner region is intended to be removed from the first region, leaving it exposed, to allow its adhesion to a surface when the consumer wishes.

All these features are considered as known; however, the present invention further proposes the following features, which are considered not known in view of the existing prior art.

It is proposed that the adhesive layer also covers a second region of the first side of the flexible layer, and that the liner includes a base region adhered to the second region of the adhesive layer.

The base and first liner regions of the liner will be connected through a first fold line whose ends are approximately tangent to two cuts of the liner constitutive of anti-tear configurations, allowing to expose the first region keeping the liner attached to the second region of the adhesive layer. The anti-tear configurations prevent the separation of the base region of the liner from the second region of the adhesive layer while also prevents the tear of the liner. To achieve those results, the base region of the liner preferably extends on both sides of the fold line, and the anti-tear configurations are defined as curved cuts tangent to the fold line.

Thus, pulling the first liner region will result in its separation from the first region of the adhesive layer until it reaches the first fold line. A pulling force exerted on the first liner region of the liner will be perpendicular to the first fold line and thus perpendicular to the points of tangency between the first fold line and the cuts constitutive of anti-tear configurations located at the ends of the first fold line, preventing further separation of the liner without causing a breakage by tearing thereof, and thus stopping the separation of the liner from the adhesive layer at the first fold line.

This ensures that the base region of the liner remains attached to the second region of the adhesive layer when the user exposes the first region, and that the liner remains attached to the rest of the adhesive label through the first fold line and keeps away from the exposed first region of the adhesive layer by folding, the first liner region of the liner overlapping the base region, thus preventing the generation of waste.

Preferably, the adhesive layer completely covers the flexible layer, or is defined as a straight band completely covering a strip of the flexible layer, i.e. a band-shaped region thereof.

According to that, the first and second regions of the adhesive layer completely cover the surface of the flexible layer or the surface of the strip of the flexible layer covered by the adhesive layer. Alternatively, some regions of the adhesive layer, different from the first and second regions, can be passivated, for example by printing thereon, to eliminate its adhesive capacity or covered by passivating regions of the liner. In a less preferred embodiment the areas outside the first and second region are completely devoid of adhesive.

According to a preferred embodiment, the flexible layer is elongated defining a central portion and two extreme portions. In this case, the first region of the adhesive layer is placed on one of the extreme portions, on the first side, and the other extreme portion containing, on the first side, a surface intended to be adhered to the first region by bending the central portion, creating a closed loop, for example for attaching the flexible self-adhesive label to a suitcase handle for its identification.

According to an alternative embodiment, the adhesive layer covers also a third region. Said third region can be defined, for example, on the second side of the flexible layer, opposed to the first side, typically behind the first and/or second regions, for example for attaching the flexible self-adhesive label on an inner side of a flap of a closeable product for the closing of said flap by adhering the first region on an external surface of the closeable product. Having the adhesive layer on both sides of the flexible layer allows for a smaller label.

Alternatively, the third region may be defined on the first side of the flexible layer, typically adjacent to the first and/or second regions, for example for attaching the flexible self-adhesive label on an outer side of a flap of a closeable product for the closing of said flap by adhering the first region on an external surface of the closeable product. In this case, the adhesive layer is applied only on areas of a first side of the flexible layer, leaving a second side opposite to the first side free of adhesives. This feature allows keeping manufacturing costs low.

Preferably, the entire adhesive layer is covered by the first, second and third regions, the adhesive layer completely covering the flexible layer or completely covering the strip of the flexible layer, as exposed above. Alternatively, some regions of the adhesive layer, different from the first, second and third regions, can be passivated, for example by printing thereon, to eliminate its adhesive capacity or covered by passivating regions of the liner. In a less preferred embodiment the areas outside the first, second and third region are completely devoid of adhesive.

The third region is intended to be permanently adhered to a surface of the closeable product, typically a surface of the closeable product adjacent to an opening of the closeable product to be closed, while the first region is intended to be adhered to another surface of the closeable product for the closure of the closeable product at the moment when the consumer wishes to close the closeable product, preventing the opening of the closeable product opening.

Preferably, all the regions of the adhesive layer provide the same adhesion, for example removable adhesive or permanent adhesive, but optionally the adhesion of some of the regions could be reduced by applying a passivating pattern thereon, typically by printing.

The permanent adhesion of the first and third regions on the surface of the closeable product will require a breakage of the closeable product to open it, for example by tearing a portion of a paper wall constitutive of said closeable product or by peeling the surface thereof, the label providing a tamper-evident closure.

Alternatively, the self-adhesive label may comprise a weakened line, which could be broken after the permanent adhesion of the first and third regions on surfaces of the closeable product to open the closeable product providing a tamper-evidence feature. The weakened line will be placed between the first region and the third region.

In an alternative embodiment, the adhesive layer in the first region provides a removable adhesion allowing for multiple attachments and detachments of the first region on a surface, typically a surface of a closeable product.

According to an embodiment of the present invention, the first region may be located between the third region and the second region. In such a case, the first liner region may have a length, measured in a direction perpendicular to the first fold line, greater than the length, measured in a direction perpendicular to the first fold line, of the base region, allowing that when the first liner region is separated from the first region, and said first liner region is superimposed on the base region, part of the first liner region protrudes from the boundary of the base portion and preferably also protrudes from the boundary of the flexible layer.

In addition, this configuration allows the same movement of separating the first liner region from the first region to pull the flexible layer for adhesion to the closeable product.

Alternatively, it is proposed that the second region to be located between the third region and the first region.

Optionally, it is proposed that the adhesive layer also covers a fourth region of the first side of the flexible layer located on one side of the first fold line opposite to the side where the first region is located, and where the liner does not cover said fourth region, leaving it exposed. That is to say, on one side of the first fold line the first region will be located, and on the other side of the first fold line the third region, the second region and also the fourth region of the adhesive layer will be located.

The first liner region may also include a second fold line, parallel to the first fold line, defined by discontinuous cuts of the liner. Preferably, the distance between the second fold line and the first fold line will be equal to or less than the separation between the third region and the first fold line.

The second fold line allows the first liner region to be folded in half when separated from the first region, reducing, or eliminating its interference between the first region and the closeable product.

According to one embodiment, the liner includes discontinuous cuts on the first fold line, to facilitate its folding.

The zones of the first side of the flexible layer different from the first, second and third regions, and different also from the fourth region of existing, are not covered by the adhesive layer or are covered by the adhesive layer and have their adhesive capacity inhibited by an inhibition treatment. The zones covered by the first, second third and fourth regions may completely occupy the entire surface of the first side of the flexible layer or a continuous strip of said first side. In a less preferred embodiment the areas outside the first, second, third and fourth region are completely devoid of adhesive.

The two curved cuts of the liner may be located on one side of the first fold line opposite to the side where the second region is located. Preferably, the base region of the liner will extend beyond the first fold line, on both sides of the first liner region, in the areas delimited by these curved cuts.

The first liner region may extend over a portion of the first side of the flexible layer not covered by the adhesive layer or covered by the adhesive layer but with the adhesive capacity inhibited by an inhibition treatment, constituting a grip tab.

It is understood that the third region may be adhered, before its adhesion to the closeable product, on an additional liner. Preferably, said additional liner is not overlapped with the liner described above, for example the additional liner could surround the liner described above, both liners being obtained from the same cut or die-cut strip reducing its cost and making it possible to separate the liner from the additional liner.

The present invention also proposes a closeable product comprising a closeable product including an opening and a closure, the closure being intended for closing the opening, and a flexible self-adhesive label as described above.

In this closeable product, the flexible self-adhesive label will be attached to, or integrated in, a support surface of the closeable product. According to that, the self-adhesive label includes a third region adhered to the support surface of the closeable product, or at least a portion of the closeable product constitutive of the support surface is made of a flexible layer with the pressure-sensitive adhesive layer applied directly thereto, said portion of the closeable product having the self-adhesive label integrated therein.

The support surface may be defined on the closure of the closeable product, in which case the first region of the adhesive layer will be located in a region of the label opposable to a surface of the closeable product adjacent to the closure; or alternatively the support surface may be defined on a product surface adjacent to the closure, the first region of the adhesive layer being located in a region of the label opposable to a surface of the closure.

According to the above, the self-adhesive label will be adhered to, or integrated in, the closure of the closeable product, in which case the self-adhesive label, or the portion of the closure constitutive of the self-adhesive label, will include a portion, with the first region of the adhesive layer therein, opposable to a surface of the closeable product adjacent to the closure.

Alternatively, the self-adhesive label will be adhered to, or integrated in, a portion of the closeable product adjacent to the closure, in which case the self-adhesive label, or the portion of the closeable product constitutive of the self-adhesive label, will include a portion, with the first region of the adhesive layer therein, opposable to a surface of the closure of the closeable product.

This configuration allows a user to selectively expose the first region of the adhesive layer by peeling the first liner region of the liner, and then adhere the exposed first region on a surface of the closeable product with the closure in the closed position, providing a seal or a tamper-evident seal of the closure of the closeable product.

Optionally, the flexible self-adhesive label is adhered to a support surface of the closeable product through the third region of the adhesive layer.

It is also proposed to include a weakened line on the closeable product around the surface where the first region is intended to be adhered and/or around the surface where the third region is adhered, providing a tamper-evident feature.

Preferably, the closeable product and the flexible layer of the self-adhesive label, and optionally also the protective liner, are made of the same material, for example a paper based material, or a plastic based material such PP, PE, PVC, PET, PO, PU or other polymers, so that they can be disposed together facilitating its recyclability.

Geometric position references, such as parallel, perpendicular, tangent, etc., shall be understood to allow deviations of up to +5° with respect to the theoretical position defined by such nomenclature.

Other features of the invention will appear in the following detailed description of an exemplary embodiment.

### BRIEF DESCRIPTION OF THE DRAWINGS

The foregoing and other advantages and features will be more fully understood from the following detailed description of an exemplary embodiment with reference to the attached drawings, which are to be taken in an illustrative and not limitative manner, wherein:

FIGS. 1A, 1B and 1C show a view of the flexible adhesive label according to a first embodiment, wherein the second region of the adhesive layer is located between the first and third regions of the adhesive layer;

FIG. 1A shows, with the liner removed, the first side of the first film with the adhesive layer on the first, second, third and fourth regions, indicated by a hatching, the rest of the first side being devoid of adhesive or covered with a passivated adhesive;

FIG. 1B shows the flexible adhesive label shown in FIG. 1A with the liner adhered over the first and second regions of the adhesive layer; and

FIG. 1C shows the flexible adhesive label shown in FIG. 1B but with the first liner region of the liner separated from the first region and superimposed over the base region of the liner;

FIGS. 2A, 2B and 2C show a view of the flexible adhesive label according to a second embodiment similar to that shown in FIGS. 1A, 1B and 1C, but wherein the first liner region of the flexible layer includes a second fold line that allows the first liner region to be folded in half when separated from the second region of the adhesive layer, the two folded halves being superimposed on the base region of the first liner;

FIGS. 3A, 3B and 3C show a view of the flexible adhesive label according to a third embodiment similar to that shown in FIGS. 1A, 1B and 1C, but wherein the second adhesive zone is located between the first and third adhesive layer zones;

FIG. 4 shows a perspective view of a closeable product, in the form of a flexible pouch, comprising the flexible adhesive label with the third region of the adhesive layer adhered to a surface adjacent to the closeable product opening, the remainder of the label overhanging the edge of the closeable product opening, and the liner adhered to the first and second regions of the adhesive layer; this embodiment including in dashed lines three different locations for a weakened line constitutive of a tamper-evident feature;

FIG. 5 shows the same closeable product as in FIG. 4 but in which the closeable product has been folded by overlapping the edge of the opening with a surface of the closeable product to which the second region of the adhesive layer has been adhered;

FIG. 6 shows three embodiments of the closeable product after the reopening thereof by breaking the tamper-evident feature through the three alternative positions of the weakened lines;

FIGS. 7 and 8 shows a front view, in open and closed positions, of the closeable product being an envelope with a self-adhesive label with a third region on the first side adhered on an outer side of the envelope flap;

FIGS. 9 and 10 shows a front view, in open and closed positions, of the closeable product being an envelope with a self-adhesive label with a third region on the second side adhered on an inner side of the envelope flap;

FIG. 11 shows a front view, in extended position and folded position, of the self-adhesive label being an elongated label constitutive of a luggage tag with the first and second regions being placed on one extreme portion thereof.

### DETAILED DESCRIPTION OF AN EXEMPLARY EMBODIMENT

The attached figures show illustrative, not limitative examples of embodiments of the present invention

The present invention concerns to a flexible adhesive label formed by a flexible layer 10 with a layer of pressure-sensitive adhesive 20 distributed over some selected areas of a first side of the flexible layer, and with a liner 30 adhered over some of said selected areas.

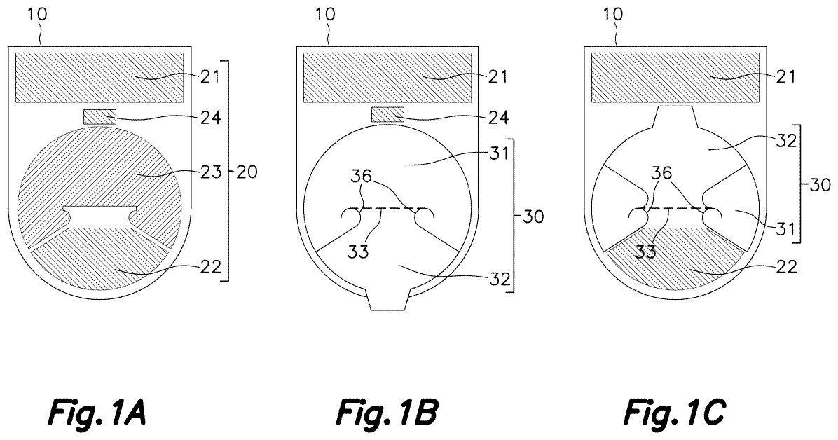

According to a first embodiment of the invention, shown in FIGS. 1A, 1B, 1C, 4 and 5, on the flexible layer are disposed, in succession, a third region 21, a fourth region 24, a second region 23 and a first region 22 of the adhesive layer 20, as shown in FIG. 1A.

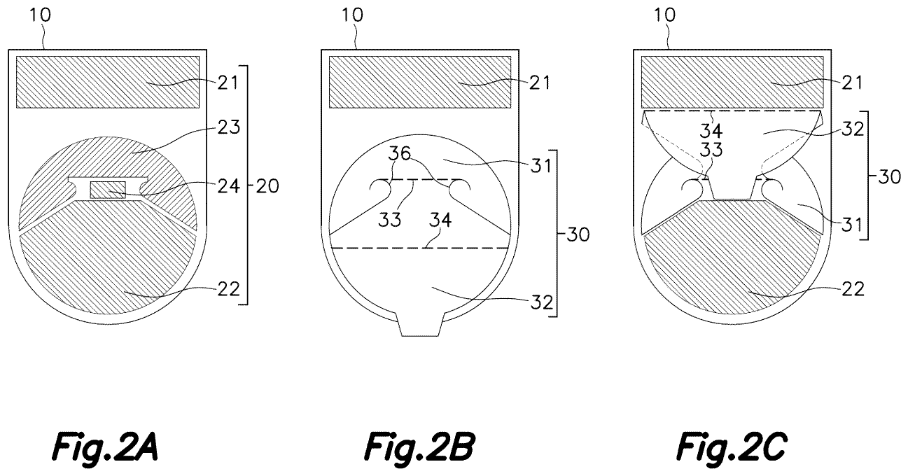

In a standby position, shown in FIG. 2B, the liner 30 will have a base region 31 adhered over the second region 23 and a first liner region 32 adhered over the first region 22 of the adhesive layer 20. Furthermore, in the standby position, the third region 21 of the adhesive layer 20 will not be covered by any additional liner, allowing it to be adhered over a surface of a closeable product.

In this example, the liner 30 is circular in shape, and includes two curved cuts 36 on both sides. Between the two curved cuts 36 is defined a first fold line 33 tangent at its ends to said two curved cuts 36. Optionally, the first fold line 33 will include discontinuous cuts to facilitate its folding.

The set of curved cuts 36 and first fold line 33 define the boundary between the first region 22 and the second region 23 of the adhesive layer 20.

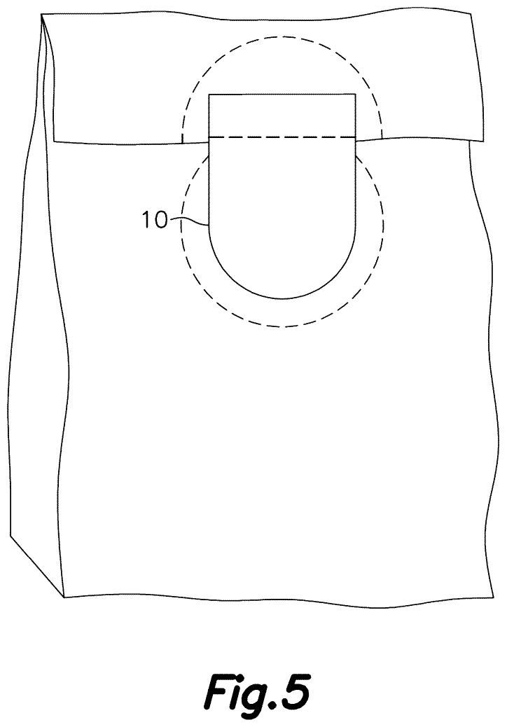

In a closing position, shown in FIG. 1C, the first liner region 32 is separated from the first region 22 of the adhesive layer 20, leaving it exposed, proceeding to fold the liner 30 along the first fold line 33, overlapping the first liner region 32 to the base region 31. Being the label in said closing position, it is possible to proceed to adhere the first region 22 on an outer surface of the closeable product causing its closure, as shown in FIG. 5, without generating waste.

In this example, a fourth adhesive region 24 is located between the third region 21 and the second region 23 of the adhesive layer 20 which is exposed in the standby position, as it is not covered by the liner 30. One end of the first liner region 32, in this case a grip tab will be overlapped and adhered to said fourth region 24 when placed in the closed position, retaining it in said closed position

Optionally, the fourth region 24 may be surrounded by the second region, exposed and accessible through an opening of the base region 31 of the liner 30.

A second embodiment, shown in FIGS. 2A, 2B and 2C, is very similar to that shown in FIGS. 1A, 1B and 1C, but wherein the first liner region 32 of the liner 30 includes a second fold line 34 parallel to the first fold line 33, defined by discontinuous cuts of the liner 30.

This allows that, in the closed position, the first liner region 32 of the liner 30, can easily be folded in half along said second fold line 34, reducing its overall length from the first fold line 33, remaining folded and superimposed on the base region 31 of the liner 30.

In this second embodiment, a fourth region 24 of the adhesive layer 20, located between the first and second regions 22, 23, adjacent to the first fold line 33, is also optionally included.

Said fourth region 24 will be covered by a portion of the first liner region 32 adjacent to the first fold line 33, when in the standby position, and upon moving to the closed position will be briefly uncovered, by separating the first liner region 32, but will immediately be covered again by adhering over it a distal end away from the first fold line 33 of the first liner region 32, in this example shown in FIG. 2C a grip tab, located above the fourth region 24 by folding the first liner region 32 along the second fold line 34.

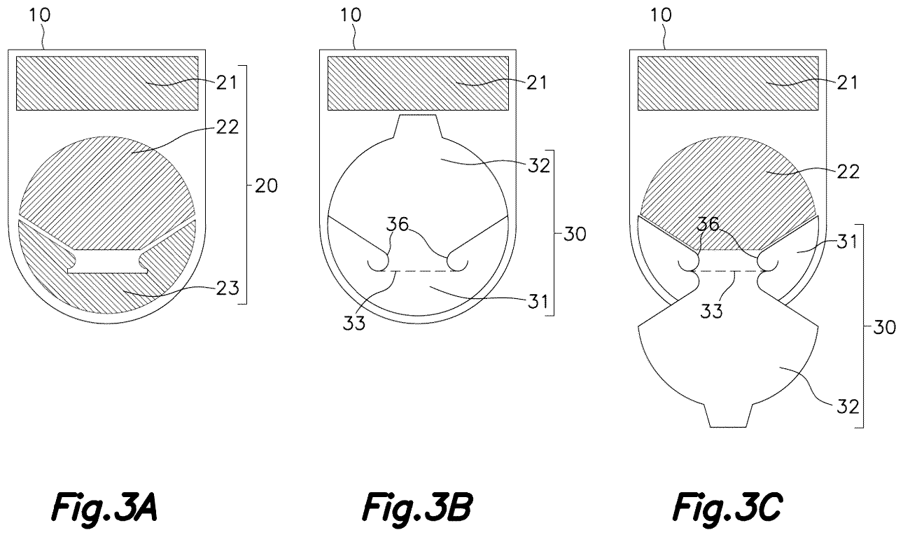

FIGS. 3A, 3B and 3C show a third embodiment of the invention very similar to that shown in FIGS. 1A, 1B and 1C, but with the position of the first and second regions 22, 23 interchanged, and thus also with the position of the base and first liner regions 31, 32 of the liner 30 interchanged.

According to the first embodiment, the first region 22 is located in the region of the flexible layer 10 furthest from the third region 21, and the first liner region is folded towards the third region 21, when folded by the first fold line 33 in the closed position.

On the other hand, in the third embodiment, it is the second region 23 that is located in the region of the flexible layer 10 furthest away from the third region 21. In this case, the first liner region 32 of the liner 30 is folded away from the third region 21 when folded along the first fold line 33 in the closed position. This allows the first liner region 32 to remain away from the first region 22, without interfering with the process of closing the closeable product, and also allows a single movement of pulling the end of the first liner region 32 to expose the first region 22 while pulling the entire adhesive label to adhere the first region 22 to a surface of the closeable product.

According to an embodiment, the self-adhesive label can be a luggage tag for attaching information to a luggage handle. In this embodiment the self-adhesive label is an elongated label with the first and second regions of the adhesive layer being located at one extreme thereof.

The peeling of the first region of the adhesive layer, by the removal of the first liner region 32 of the liner 30, allows for the adhesion of the first region to be adhered on the opposed extreme end of the same label, producing the folding of the label forming a closed loop.

According to an alternative of the same invention, shown in FIG. 11, the elongated label can also include, on the opposed extreme thereof away from the extreme portion containing the first and second regions of the adhesive layer, an additional first region and an additional second region of the adhesive label covered with an additional liner with the same configurations than the liner covering the first and second regions of the adhesive layer on the opposed extreme portion of the label. According to this embodiment, the first region and the additional first region can be adhered to each other providing a strong bonding.

The present invention also covers an alternative embodiment, not shown in the drawings, in which only one extreme portion of the elongated label contains the first and second regions of the adhesive layer, the opposed extreme portion being devoid of adhesive layer or including only passivated or covered adhesive layer.

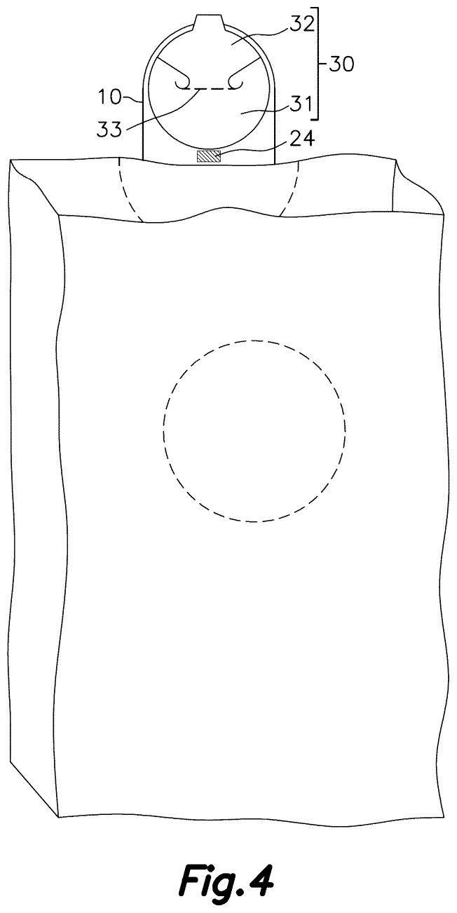

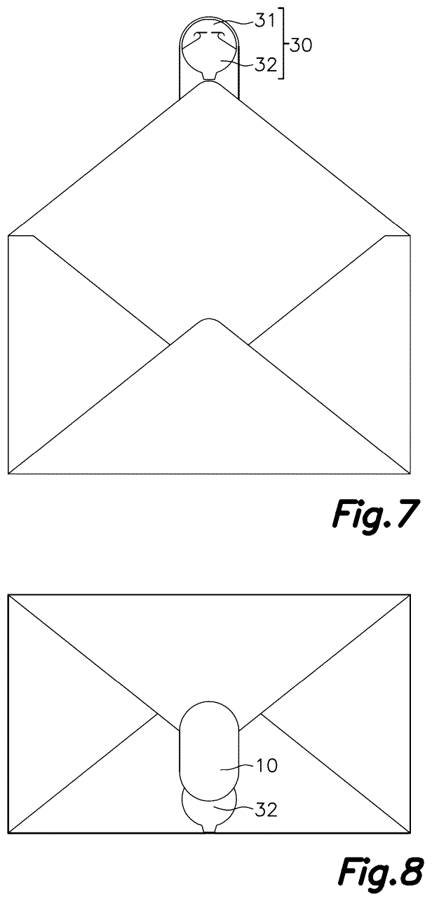

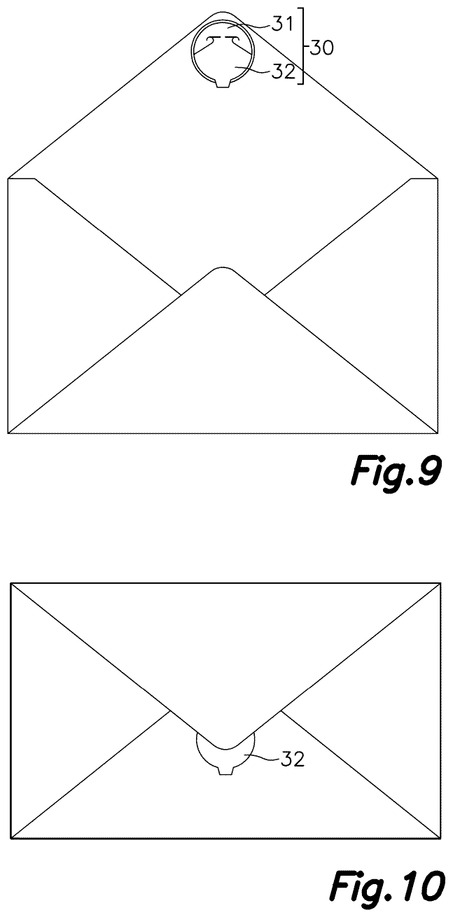

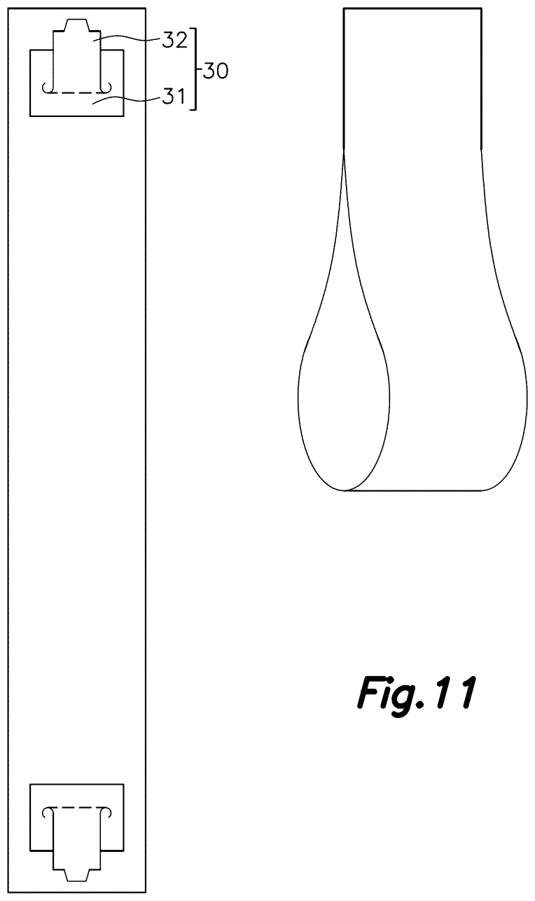

The proposed self-adhesive label can also be attached to, or integrated in, a closeable product such a paper bag, as shown in FIGS. 4, 5 and 6, and envelope, as shown in FIGS. 7 to 10, or a rigid box.

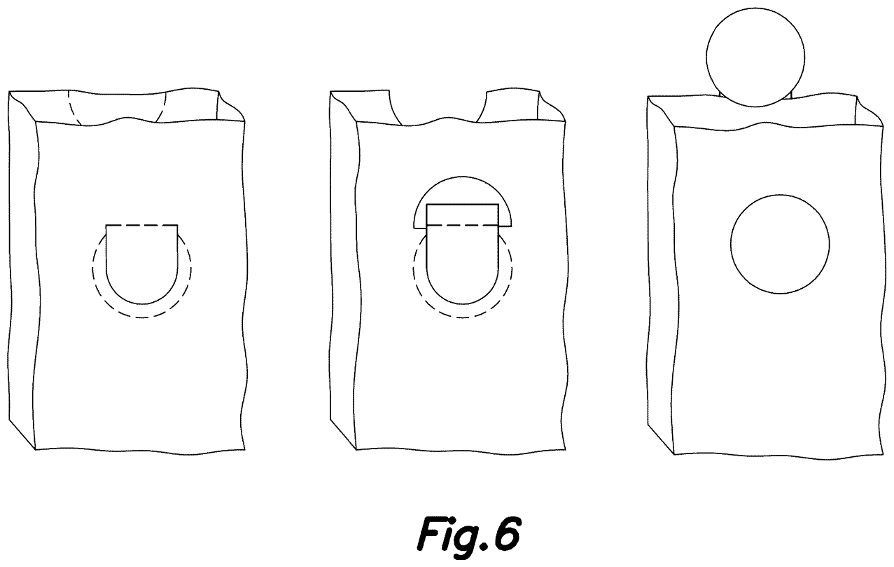

It is also proposed to include tamper-evident features in the self-adhesive label, for example a weakened line dividing the portion of the flexible layer containing the first and second regions 22 and 23 from the portion containing the third region 21. This option is shown as a dashed line transverse to the label in FIG. 5, and the result of its breaking is shown in left view of FIG. 6.

Alternatively or additionally, the tamper-evident features can be included in the closeable product, for example as a weakened line surrounding the surface where the third region is adhered. This option is shown as a semi-circular dashed line in FIGS. 4 and 5, and the result of its breaking is shown in central view of FIG. 6.

Alternatively or additionally, the tamper-evident features can be included as a weakened line surrounding the surface where the first region is intended to be adhered. This option is shown as a circular dashed line in FIGS. 4 and 5, and the result of its breaking is shown in right view of FIG. 6.

Alternatively, the tamper-evident feature could comprise the configuration of the surface of the closeable product, where the first region and/or the third region is/are adhered, to be peelable. The peelable configuration will be attached to the surface of the closeable product with an attachment whicker than the adhesion force of the first region and/or the third region thereon.

Similar tamper-evident features can be included in the alternative embodiments shown in the rest of the Figures.

According to an alternative, the closeable product can also include, an additional first region and an additional second region of the adhesive label covered with an additional liner with the same configurations than the liner covering the first and second regions of the adhesive layer described above. Those additional first region and additional second region will be placed on the surface where the first region of the label is intended to be adhered, so that the first region will be adhered to the additional first region providing a strong bonding.

According to this embodiment, the first region and the additional first region can be adhered to each other providing a strong bonding.

1. Flexible self-adhesive label with a covered adhesive region selectively peelable, the label comprising:
a flexible layer with a first side and a second side oppositely disposed to each other;
a pressure-sensitive adhesive layer configured to cover at least a first region of the first side of the flexible layer;
a liner with a first liner region adhered over the first region of the first side of the flexible layer configured to be removed from the first region leaving the first region of the flexible layer with pressure-sensitive adhesive layer exposed;
the adhesive layer also configured to cover a second region of the first side of the flexible layer
the liner includes comprising a base region attached to the second region, the base region and the first liner region being connected through a first fold line whose ends are approximately tangent to two cuts comprising anti-tear configurations of the liner, and configured to allow the first region to be exposed and to keeping the liner attached to the second region of the adhesive layer.

2. The flexible self-adhesive label according to claim 1 wherein the flexible layer is elongated defining a central portion and two extreme portions, the first region of the adhesive layer being on a first one of the extreme portions, on the first side of the flexible layer, and a second one of the extreme portions containing, on the first side thereof, a surface superimposable to the first region by bending the central portion resulting in the first one and the second one of the extreme portions being adhered to one another.

3. The flexible self-adhesive label according to claim 2 wherein the surface of the second one of the two extreme portions, configured to be adhered to the first region, further comprises an additional first region and additional second region of the adhesive layer covered by an additional liner including an additional base region, attached to the additional second region, the additional base region and the additional first liner region being connected through an additional first fold line whose ends are approximately tangent to two cuts comprising anti-tear configurations of the additional liner, and configured to allowing the additional first region to be exposed and to keep the additional liner attached to the additional second region of the adhesive layer.

4. The flexible self-adhesive label according to claim 1 wherein the adhesive layer is configured to also cover a third region of the second side of the flexible layer the liner being configured not to cover the third region, the third region being adherable to a first surface of a flap of a closeable product.

5. The flexible self-adhesive label according to claim 1 wherein the layer of pressure-sensitive adhesive is configured to also cover a third region of the first side of the flexible layer, the liner being configured not to cover the third region, the third region being adherable to a first surface of a flap of a closeable product.

6. The flexible self-adhesive label according to claim 5 wherein the label comprises a weakened line configured to provide a tamper-evidence feature between the first region and the third region.

7. The flexible self-adhesive label according to claim 5 wherein the first region is located between the third region and the second region.

8. The flexible self-adhesive label according to claim 5 wherein the second region is located between the third region and the first region.

9. The flexible self-adhesive label according to claim 8 wherein the first liner region includes a second fold line parallel to the first fold line, defined by discontinuous cuts of the liner.

10. The flexible self-adhesive label according to claim 8 wherein the adhesive layer is configured to also cover a fourth region of the first side of the flexible layer, located on one side of the first fold line opposite to the side where the first region is located, the liner being configured not to cover and leave exposed the fourth region.

11. The flexible self-adhesive label according to claim 9 wherein the adhesive layer is further configured to cover a fourth region of the first side of the flexible layer located on the same side of the first fold line as the first region, and wherein the liner being configured to cover the fourth region.

12. The flexible self-adhesive label according to claim 1 wherein the two anti-tear configurations of the liner are curved cuts or are located on one side of the first fold line opposite to the side where the second region is located.

13. The flexible self-adhesive label according to claim 1 wherein the first liner region extends over a portion of the first side of the flexible layer not covered by the adhesive layer or covered by the adhesive layer but with an adhesive capacity inhibited by an inhibition treatment, comprising a grip tab.

14. A closeable product comprising a container including an opening and a closure configured to close an opening and a flexible self-adhesive label according to claim 1 wherein:
the flexible self-adhesive label is attached to, or integrated in, a support surface of the closeable product;
the support surface and the first region of the adhesive layer being configured to provide a seal or a tamper-evident seal of the closure of the closable product.
the support surface is defined on the closure of the closeable product, the first region of the adhesive layer being located in a region opposable to a surface of the closeable product and adjacent to the closure; or
the support surface is defined on a product surface adjacent to the closure, the first region of the adhesive layer being located in a region opposable to a surface of the closure.

15. The closeable product according to claim 14, further comprising a weakened line around the surface where the first region is intended to be adhered or around the surface where the third region is adhered, providing a tamper-evident feature.

16. The flexible self-adhesive label according to claim 1 wherein the cuts constitutive of anti-tear configurations do not affect the flexible layer.
